(19) United States
(12) Patent Application Publication
(10) Pub. No.: US 2002/0121143 A1
(43) Pub. Date: Sep. 5, 2002

(54) Process and device for checking forces applied on a fuel assembly in a transport container

(75) Inventor: Gerard Soriano, Carnols (FR)

Correspondence Address: PEARNE & GORDON LLP, 526 SUPERIOR AVENUE EAST, SUITE 1200, CLEVELAND, OH, 44114-1484, US

(73) Assignee: Compagnie Generale Des Matieres Nucleaires

(21) Appl. No.: 09/992,608

(22) Filed: Nov. 19, 2001

(30) Foreign Application Priority Data
Nov. 28, 2000 (FR) 00 15317

(51) Int. Cl. G01N 3/08

(52) U.S. Cl. 73/856

(57) ABSTRACT

Process and device for controlling force applied on a fuel assembly in a transport container.

The check is undertaken by inserting a check template (10) in a housing of the container designed to receive the assembly. The template (10) is fitted with force transducers (20) right up against each of the devices provided in the housing, to ensure the clamping of the assembly. The preloads exerted by all the devices which are fitted in the housing are thus measured simultaneously, in a reliable and reproducible manner. Software facilitates conveniently comparing measurement results with minimum and maximum predefined limit values.

### DESCRIPTION

1. Technical Field

The invention involves a process designed to check the preloads applied on a nuclear fuel assembly during its transport inside a housing provided for this purpose in a transport container.

More specifically, the invention involves the checking of forces exerted on the assembly by clamping means installed in the housing, in defined positions. The function of these means of clamping is to immobilize the assembly in its housing during transport.

The aim of the invention device is also to facilitate implementation of this process.

The process and device according to the invention can be used to check forces applied on any type of assembly during transport. They involve notably both new assemblies as well as spent assemblies and are applied indifferently to unpacked assemblies and to the transport of assemblies placed individually in cases. In a specific non-restrictive application of the invention, the assemblies transported are square-shaped assemblies of MOX type, intended for PWR or BWR nuclear reactors.

2. Prior Art

The nuclear fuel assemblies used in nuclear reactors must be transported from their site of manufacture to the reactor site when they are new, and from the reactor site to a dismantling site when they are spent.

In order to carry out each of these journeys, normally each assembly is placed individually in a housing provided for this purpose in a basket, itself in a transport container.

So as to guarantee the mechanical integrity of the packing during its transport, the assemblies are secured in their housings before closing the container. For this purpose clamping devices integrated in the basket are used. These devices are either in the clamped position during transport, or unclamped during handling or when the housings are empty.

More specifically, the clamping devices are located on two adjacent sides of each housing, at defined levels so as to be able to act laterally on an assembly received in the said housing, on the spacer grids of this assembly. The clamping devices are fitted with support pads which clamp on the front sides of the assembly, in this way clamping the latter transversely against the opposite sides of the housing.

The preloads must be sufficient to prevent any movement of the assembly in its housing, under the effect of dynamic strains to which it is subjected during transport.

Furthermore, preloads must also remain below a maximum value which depends on the structural resistance of the fuel assembly spacer grids. This structural resistance itself varies depending on the type of assembly transported, and notably depending whether it involves a PWR reactor fuel assembly or a BWR reactor fuel assembly.

For each series of support pads, the preloads that are applied on the assembly must therefore be as near as possible to a nominal value, which falls between a minimum and maximum value. These different values vary notably depending on the position of the support pads in relation to the assembly, i.e. depending whether clamping is upwards, downwards or sideways.

Sound operation of clamping devices and the force values they deliver are checked on the new containers, after each maintenance campaign and more and more frequently before each transport campaign.

In the present state of technology, the forces exerted by the clamping devices are measured using a load cell fixed on the end of a rod. The rod facilitates inserting the indicator inside each cell and to move it manually successively to the right of each clamping pad to measure the forces that they exert one by one.

This checking process has many disadvantages. In this way, the measurements carried out are difficult and long to make. In fact, the same housing can contain up to 18 clamping pads, divided on two sides, and the same container can comprise up to 12 housings.

Furthermore, the result of measurements undertaken is highly dependent on the precise position of the load cell as compared to each pad. Because this positioning is made manually by the operator, the results are not very repetitive or reliable which renders them questionable.

### ACCOUNT OF THE INVENTION

The aim of the invention is precisely a checking process of preloads applied on an assembly received in a housing provided in a transport container, as this process facilitates improving the accuracy of measurements while reducing operating time as compared with processes of previous technology.

In compliance with the invention, this result is obtained through the means of a checking process of the preloads applied on a nuclear fuel assembly through the use of clamping means installed in defined positions inside a housing provided in a transport container, typified in that it comprises the following successive stages:

insertion, in the said housing, of a check template fitted with force measurement means actually placed right up against each of the said positions; and

simultaneous measurement of forces exerted by all the clamping means installed in the housing.

The use of a check template with force measurement means actually placed opposite the clamping pads facilitates guaranteeing the reliability and reproducibility of the measurements and considerably reducing their length. As the check template has exactly the same outside geometry as the assembly intended to be received in the housing, measurements obtained when the clamping devices are in their clamped position are perfectly representative of the forces that will be applied later on the assembly.

In a convenient realization method of the invention, forces measured are then compared with predefined minimum and maximum values.

In this case, the comparison is conveniently made through means of measurement processing software.

It is also possible to display results of the comparison thus made.

Preferably, the check template is fitted with measurement means on two adjacent sides of the said template.

Furthermore, the measurement means may be notably constituted by load cells.

The aim of the invention also provides a checking device for preloads applied on a nuclear fuel assembly through clamping means installed in defined positions inside a housing provided in a transport container, typified in that it comprises a check template suitable for being introduced into the housing, as the said template is fitted with force measurement means suitable for being actually localized right up against each of the said positions, when the template is placed in the housing, in order to carry out simultaneous measurement of forces exerted by all the clamping means installed in the housing.

### BRIEF DESCRIPTION OF THE DRAWINGS

At present, a convenient realization method of the invention will be described as a non-restrictive example by referring to the attached drawings, in which:

FIG. 1 is a perspective which diagrammatically represents a preloads control device in compliance with the invention; and

FIG. 2 is a cross-section which shows diagrammatically a housing of a transport container in which the check template of the control device in FIG. 1 has been inserted.

### DETAILED DESCRIPTION OF A CONVENIENT REALIZATION METHOD OF THE INVENTION

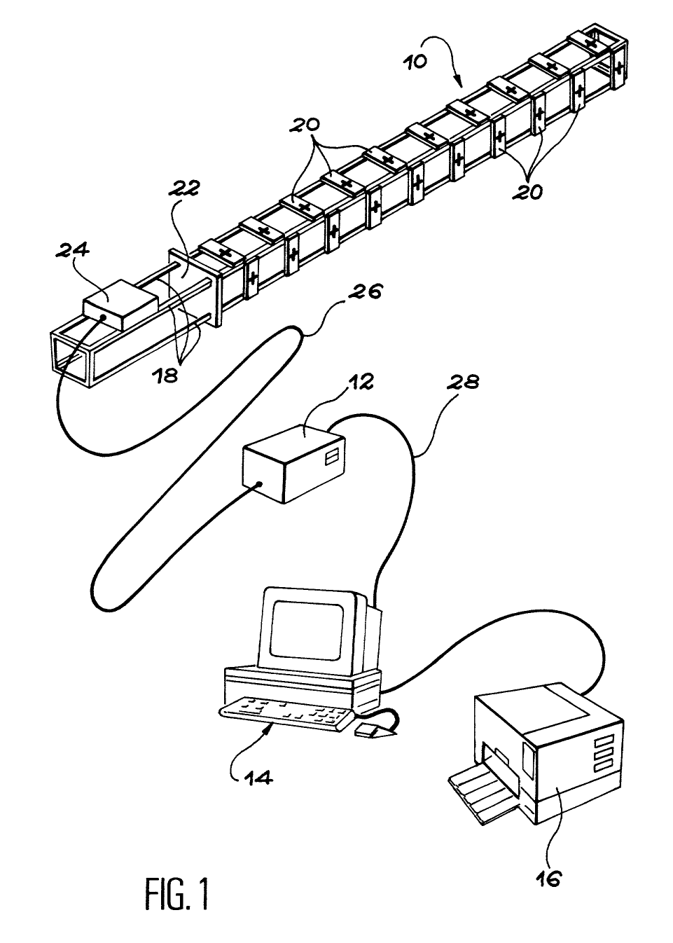

As is shown diagrammatically in FIG. 1, a control device in compliance with the invention comprises mainly a check template 10. In the realization method shown, the device also comprises an electronic unit 12, a computer 14 and a printer 16.

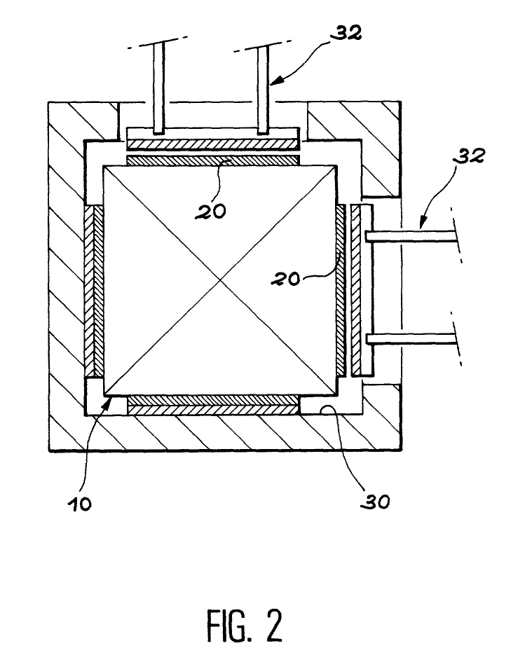

The check template 10 has the exact identical shape and outside dimensions of a nuclear fuel assembly. More specifically, the shape and dimensions of the check template 10 correspond to those of the assembly which is to be normally received in the housing 30 (FIG. 2) where the clamping means 32 must be checked. According to an arrangement well known to the experts and which will therefore not be described here in detail, several housings 30 of this type are usually fashioned in a basket of a transport container.

In the convenient realization method of the invention illustrated in FIG. 1, the check template 10 is square in shape. This section corresponds to most fuel assemblies used, notably in water reactors.

In practice, the template 10 can have a rigid structure of whatever design. In the convenient realization method represented, this structure is materialized by a recessed frame formed by an assembly of rigid rods 18 which extend as a function of the edges of the template.

On two of its sides, next to one another and visible in FIG. 1, the check template 10 is fitted with force measurement means 20. These force measurement means 20 are constituted preferably by load cells, i.e. by flexible plates fitted with strain gauges. The flexible plates are fixed on the rigid rods 18 at precise positions. These positions are chosen so as to coincide with the defined positions at which the clamping means 32 are located inside the housing 30 provided to receive the assembly.

In this way when the check template 10 is inserted in the housing 30 provided to receive the assembly, one of the force measurement means 20 is actually localized right up against each of the clamping means 32 positions. Manoeuvring each of the clamping means therefore has the effect of deforming the flexible plates by a value representative of the clamping force which is applied. The strain gauges borne by the plates measure the deformations of the flexible plates and consequently the value of each of the preloads.

In order to obtain an accurate axial position for the check template 10 inside the housing 30 provided to receive the assembly, the template can be fitted with an upper horizontal plate 22 designed to come up against the upper side of the basket. As a variant the axial position of the template can also be ensured by coming against its lower extremity (to the right on the drawing) against the bottom of the housing 30.

The strain gauges of the measurement means 20 are connected by electrical leads (not shown), to a junction box 24 assembled on the upper part of the template 10, above the upper horizontal plate.

A flexible cable 26 provides the electrical connection between the junction box 24 and the electronic unit 12. The latter contains notably a source of electricity for the strain gauges of the measurement means 20, as well as the signal processing circuits carried by the gauges. It is in this way possible to measure simultaneously the preloads applied for each of the clamping means 32 integrated in the housing 30 in which the template is placed.

In the convenient realization method of the invention illustrated in FIG. 1, the electronic unit 12 is connected by a cable 28 to the computer 14, together with its printer 16.

In this case, measurement processing software facilitates comparing, for each of the clamping means 32 equipping the housing 30, the values of the preloads measured by the force measurement means 20 with the predefined minimum and maximum limit values. The results of this comparison are displayed in real-time on the computer screen and edited by the printer each time the operator so wishes.

Of course, it is also possible to process the values of the preloads measured manually without the use of a computer. It is also possible to have recourse to measurement processing software as mentioned previously, but to use the results of the processing carried out by this software differently, for example without recourse to a printer.

In compliance with the invention and as FIG. 2 illustrates more accurately, the check is made by inserting the check template 10 in the housing 30 provided to receive the assembly instead of the latter. As has been described, each of the force measurement means 20 is then actually localized right up against each of the clamping means 32 positions, installed in the said housing.

The clamping means 32 are then handled in the same way as if the housing 30 contained an assembly. The effect of this manoeuvre is to deform the flexible plates of the force measurement means 20. This is reflected by a comparable deformation of the strain gauges. This deformation is proportionate to the clamping force applied by each of the clamping means 32, in such a way that this force is measured in the electronic unit 12, simultaneously for each of the clamping means installed in the housing 30 under consideration.

As we have seen, this measurement is conveniently completed by a comparison of each of the values measured with the predefined minimum and maximum limit values.

1. Process for checking the preloads applied on a nuclear fuel assembly, through clamping means installed in defined positions inside a housing provided in a transport container, the said process comprising the following successive stages:
insertion, in the said housing, of a check template fitted with force measurement means actually localized right up against each of the said positions; and
simultaneous measurement of the forces exerted by all the clamping means installed in the housing.

2. Process according to claim 1, in which the forces measured are later compared with the predefined minimum and maximum values.

3. Process according to claim 2, in which the said comparison is made by means of measurement processing software.

4. Process according to claim 2, in which the results of the said comparison are displayed.

5. Process according to claim 1, in which the check template is fitted with force measurement means on two adjacent sides of the said template.

6. Process according to claim 1, in which measurement means constituted by load cells are used.

7. Device for checking the preloads applied on a nuclear fuel assembly through clamping means installed in defined positions inside a housing provided in a transport container, in which the device comprises a check template suitable for being inserted in the housing, the said template being equipped with force measurement means suitable for being actually localized right up against each of the said positions when the template is placed in the housing in order to make a simultaneous measurement of forces exerted by all the clamping means installed in the housing.

8. Device according to claim 7, comprising moreover processing means suitable for comparing the forces measured with predefined minimum and maximum values.

9. Device according to claim 8, in which the processing means comprise measurement processing software.

10. Device according to claim 8, comprising moreover means for displaying the results issued by the processing means.

11. Device according to claim 7, in which the measurement means are placed on two adjacent sides of the check template.

12. Device according to claim 7, in which the measurement means comprise load cells.
